(19) United States
(12) Patent Application Publication
(10) Pub. No.: US 2005/0055267 A1
(43) Pub. Date: Mar. 10, 2005

(54) Method and system for audio review of statistical or financial data sets

(76) Inventors: Allan Chasanoff, Manhattan, NY (US); Howard Pyle IV, Brooklyn, NY (US)

Correspondence Address: WEISS & MOY PC, 4204 NORTH BROWN AVENUE, SCOTTSDALE, AZ, 85251, US

(21) Appl. No.: 10/658,610

(22) Filed: Sep. 9, 2003

(51) Int. Cl. G06F 17/60

(52) U.S. Cl. 705/10

(57) ABSTRACT

A method and system for audio review of statistical or financial data provides a non-visual mechanism for user review of one or more data sets. Financial or statistical data is analyzed and used to select musical elements, which are then generated for the user to hear a pattern of one or more data sets. The values of individual data elements can be assigned to pitches directly or a melody generating program may intelligently map the shape of the data to a melody. Statistics of the data set may be used to modify the melodic content, either by mapping deviations of data values from statistical norms or by mapping the statistics of the data set onto statistics of the generated melodies. Timbre or instrument type may be used to distinguish between simultaneously-played multiple data sets, with an individual instrument assigned to each data set. Data sets/sound elements may be provided at Internet sites and the generated sounds customized by the user, or the entire program and data sets may reside within a personal computer.

### BACKGROUND OF THE INVENTION

1. Field of the Invention

The present invention relates generally to data representation systems, and more specifically, to a method and system for generating an audible representation of statistical or financial data.

2. Background of the Invention

With the advent of computers and programs such as spreadsheets and mathematical/statistical analysis packages, a myriad of data presentation options have been provided for the review of data sets by a user of a computer system. However, typically the above-mentioned data review is provided by a visual display, such as line graphs, bar graphs, sequential pie charts and other techniques adapted for quick visual perception by the reviewer.

However, there are situations where a visual display of data is not possible, such as over a telephone. There are other situations where a visual display is not desirable, e.g., where a reviewer of data is otherwise visually occupied. Therefore, it would be desirable to use another mechanism to convey the data set information to the reviewer. One option is an audio representation of the data. Typically, audio representations of data are text-to-speech type representations, e.g., a stock quotation program may read the ticker to a reviewer in verbal form via a text-to-speech converter.

However, listening to speech requires generally full concentration and it is generally impossible to simultaneously listen to multiple data sets via a text-to-speech channel. Also speech synthesizers in general are not entertaining or relaxing as compared to musical performances or other sounds.

Therefore, it would be desirable to provide a method and system for providing non-visual review of data sets via an audible data representation that is entertaining or pleasing to a user. It would further be desirable to provide a method and system for simultaneous review of multiple data sets.

### SUMMARY OF THE INVENTION

The above objective of providing audible review of data sets including simultaneous review of data sets is accomplished in a method and system. The system operates according to the method of the present invention and includes a processor for executing program instructions for carrying out the method. The program instructions may also be embodied in a computer program product containing an encoded representation of the program instructions for loading and executing in a general-purpose computer system.

The method reads a data set having arbitrary non-musical values representing data. The method selects audio parameters for mapping the data set to an audio output and then classifies portions of the data set to determine characteristics of an audio presentation from values or statistics of the data set. The statistics of the data set can be used to determine the statistics of components of a musical sound generation or other sound presentation. The musical sound generation may be a statistical variation on a well-known musical composition. For example, dissonances may be statistically included within a known piece of non-dissonant music, when the statistics of the data set deviate from a desired set of values for a data set.

Alternatively, the mapping may be performed by intelligent music generating algorithms, may be a strictly mathematical correspondence or the general statistics or shape of the data set may determine variations on a predetermined musical composition. The mapping or statistical variations above may be affect relationships of intervals within the music (consonance vs. dissonance), note position (pitch) within a scale, tempo, loudness, timbre (including instrument selection) or other musical characteristics. Multiple data sets may be simultaneously played using different timbres (instruments). The portions of the data set used to determine variations in the audio presentation may be individual values, statistics of groups of values, or statistics of an entire data set.

The Internet may be used to provide access to data set/sound elements that may be customized by the user, the entire program/system may be contained within a personal computer, or services may be provided over a network to a personal device such as a telephone or personal digital assistant.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which an embodiment of the invention may be practiced.

FIG. 2 is a pictorial diagram depicting musical output of a program in accordance with an embodiment of the invention.

FIG. 3 is a pictorial diagram depicting a mapping of musical ranges to data within a program in accordance with an embodiment of the invention.

FIG. 4 is a flowchart depicting a method of operation of a system in accordance with a preferred embodiment of the invention.

### DETAILED DESCRIPTION OF ILLUSTRATIVE EMBODIMENT

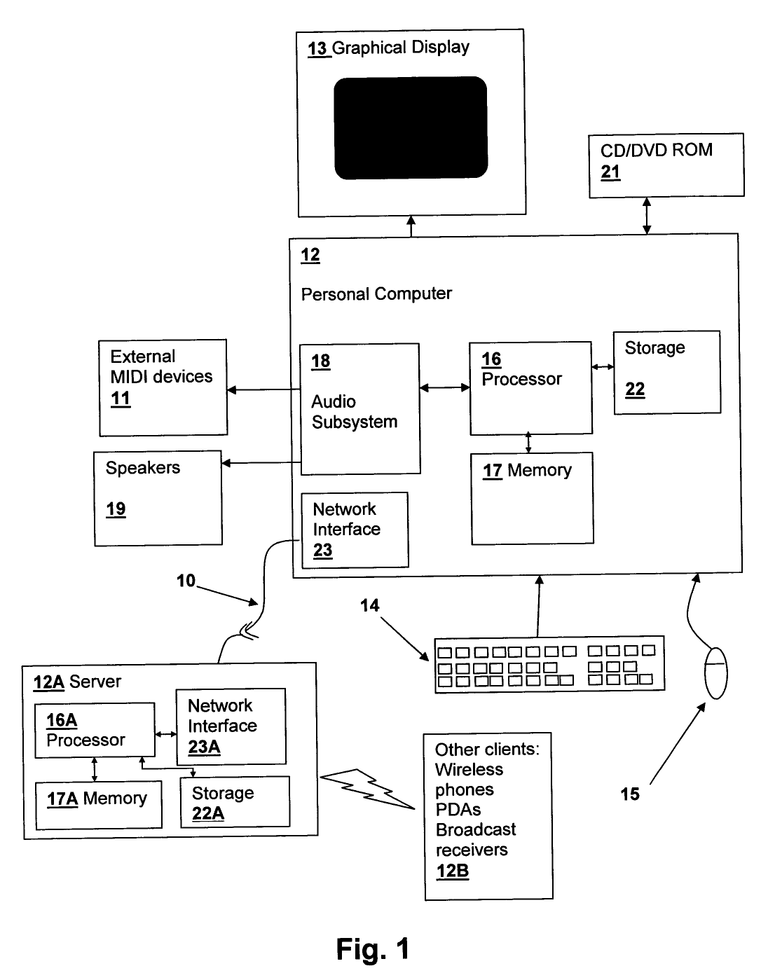

Referring now to the figures and in particular to FIG. 1, a networked computer system within which an embodiment of the present invention may be practiced is depicted in a block diagram. A personal computer 12 is coupled via a network interface 23 to a server 12A by a network connection 10, which may be an Internet connection for providing remote elements of the system of the present invention. Personal computer 12 includes a processor 16 coupled to a memory 17 for executing program instructions from memory 17. Personal computer 12 is coupled to a graphical display 13 for displaying program output and input devices such as a mouse 15 and a keyboard 14 for receiving user input. Personal computer 12 also includes a storage 22 such as one or more hard disk drives and is further coupled to a compact disc (CD)/digital video disc (DVD) 21 device for loading data and program instructions onto storage 22 and/or into memory 17. Personal computer system 12 may be coupled to a public network such as the Internet, or may be a private network such as the various “intra-nets” that are implemented within corporate offices and other installations requiring secure data communications.

Within memory 17, a program embodying a method in accordance with an embodiment of the present invention is executed by processor 16 and an output of the program is provided by an audio subsystem 18. Audio subsystem 18 is coupled to speakers 19 or other audio output such as headphones, external amplifier/speakers or the like and/or external midi devices 10 for providing an audio output in accordance with methods of the present invention.

The present invention concerns a program, computer system and method for generating sounds representing statistical or financial data sets, although other types of data may be suited for reviewing via the techniques of the present invention. Personal computer 12 is included to provide a demonstrative example of a general purpose computer having sound capability, and it will be understood by those skilled in the art that the techniques of the present invention apply to a variety of other applications such as dedicated Internet appliances and large mainframe computers having user terminals. The present invention also applies to server systems that provide services in accordance with the present invention to other clients 12B, including personal appliances such as personal digital assistants (PDAs) and Internet-enabled pagers and cellular telephones, broadcast receivers, internal corporate data sinks, muzak services, etc.

Server 12A includes a processor 16A coupled to a memory 17A and storage 22A for storing, loading and executing program instructions that may provide elements of the present invention. While personal computer 12 may provide the entire data set analysis capability, thus not requiring server 12A for operation, the method may also be performed on a remote computing system and the results stored or immediately provided for delivery to a user of personal computer 12 via network connection 10. For example, audio representations or comparisons of stock ticker information may be provided by server 12A and downloaded for play over audio subsystem 18 via a streaming audio connection. For another example, pages having graphical images of stock profiles may include links to associated static sound files that may be downloaded and played through audio subsystem 18. Alternatively, data sets can be streamed or periodically transmitted from server 12A to personal computer 12 such as up-to-date stock volume and price information, so that audio subsystem 18 may generate a musical or other audio indication of the stock price and/or activity or musical comparison of indices, stock prices, et cetera. The method may be made on real time data (e.g., as a stock ticker) or on stored “historical” data. Additionally, a musical output representation may be generated in real-time (“played”) or stored in a file for later playing including posting of sound or MIDI files (or other proprietary format) for download. The method and program instructions of the present invention may be included in packages such as database and spreadsheet applications as an alternative mechanism for viewing stored or analyzed data.

The program instructions and method of the present invention analyze data in one or more data sets, which may be financial or statistical data as mentioned above, in order to map the data or statistics of the data to musical characteristics or sound characteristics of an audio output of audio subsystem 18 (or MIDI that is later transformed to audio by external MIDI devices 11). Various parameters of the music or sounds can be selected for control by one or more data sets. In general, musical parameters include loudness, pitch (notes), tempo, scale/mode/key (e.g., minor or major), relationships of intervals (consonance/dissonance), styles of music (e.g., rock or classical) and/or particular melodic sequences. Sound parameters generally include selection of various sounds, such as sound effects, prerecorded melodies and performances of complete orchestrated compositions, volume and speed of playback.

In particular, according to certain embodiments of the present invention, data is analyzed to evaluate statistics of one or more data sets. The statistics of the data set(s) are then used for comparison purposes. The comparison can be of individual data values with the statistics of a set as a whole by “playing” through a sequence of data. The standard deviation of the data set can be used to determine which values are “rare” in the data set, and can be indicated by one of the above-mentioned musical parameters (e.g., a dissonant interval may be selected within a mode in which the musical generation algorithm is generating a tune for values which fall outside of a standard deviation of the data set). Z-scores can be used to compare multiple data sets in the same manner (e.g., a population that does not correlate well with another data set or data sets could be represented by dissonant intervals with respect to the mode of the overall composition. By assigning populations to different instruments, by way of example, a particular population may be identified by which instrument is playing the dissonant tones.)

It should be noted that the “frequency distance” between musical intervals does not correspond to the “harmonic distance” and that determination of consonant versus dissonant intervals requires a non-linear mapping between computed deviations and selected intervals in order to produce the consonance=good fit/dissonance=bad fit relationship described above. For example, a perfect fifth is a more consonant interval than a minor second, although the minor second is the closest “frequency distance” interval in the chromatic scale. Octave intervals are the closest non-unison harmonic interval, but are separated by 12 chromatic steps. Therefore, a degree of consonance of an interval is ranked and the interval selected for relative consonance versus dissonance in the above-described embodiments of the invention.

Multiple data sets can be simultaneously reviewed via audio by assigning unique timbres (instruments) to each data set, or by assigning unique ranges of pitches to each data set. For financial data, mappings such as assigning market sectors to various sections of an orchestra, such as percussion for interest rates, brass for telecom, woodwinds for currency and strings for technology. The statistics or values of multiple data sets over particular time intervals can be compared using the consonance/dissonance mappings above, in order to show the listener trend relationships via the generated sound. For example, a negative correlation (an indicator that is highly useful in detecting short-term trend relationship between prices) can be indicated between securities via a dissonance relationship, causing the negative correlation interval to “stand out”, or alternatively a particular consonant interval may be introduced, a change of key or other indicator that triggers the listener to awareness of the occurring negative correlation relationship. However, it is possible to compare two or more data sets within a single timbre by using the consonance/dissonance relationship to indicate the degree of correlation. In the latter instance, the data sets are not uniquely identifiable by sound (unless another parameter such as pitch range is assigned unique to the data set), but the application is nonetheless useful for indicating the degree of correlation between the data sets.

Alternatively, in accordance with another embodiment of the invention, a direct mapping of the data set element independent variable (x-axis) may be made by mapping the independent variable to times within the music or sound. The data elements within the set are analyzed and used to control the progress of the sound (e.g., stock price is used to determine pitch directly). The data may be analyzed in ranges or may provide a one-to-one or several-to-one correspondence between data set elements and notes of a musical composition (or sounds). Multiple data sets can be simultaneously reviewed via audio by assigning unique timbres (instruments) to each data set, or by assigning unique ranges of pitches to each data set.

Melodies can be arbitrarily generated by the data if pitch is the control variable assigned to the independent variable values of the data set elements, or an intelligent melody generation algorithm may be used to provide a more melodious response to the data. The simplest of the intelligent melody generation algorithms is assignment to particular modal scales or groups of modal scales, but very sophisticated algorithms are available that generate not only melodies that are entertaining to the average listener, but generate accompanying harmonies as well.

In any of the above-described embodiments, the character of selected or mapped musical information can be tied to the perception of a listener by certain useful associations that may be employed within the present invention, but are not limiting. These include mapping of musical key to data element trends (e.g., minor key for falling stock prices/major key for rising stock prices) and mapping of tempo to data value or data frequency (e.g., fast tempo for high volume trading, slow tempo for low volume trading). Culturally significant musical and/or sound data sets can be used to indicate data values or ranges (e.g., the “STAR WARS Theme” by John Williams may be played when a stock price hits a predetermined indicator, or Richard Wagner's “Ride of the Valkyries” may be played when trading hits a predetermined volume). Intervals in the musical scale that sound worse to a listener generally known as “dissonances” can be used to indicate negative (undesired) changes, while “consonances” can be used to indicate positive (desired) changes. Such selections are user-customizable in the software, both for the indicia that triggers a particular melodic pattern (e.g., a price point or multiple occurrences of a price point) and for the resulting pattern itself (minor/major key, melody, etc.). If the service is provided through a website, the user-customized selections can be stored at the website, or via cookies or some other mechanism. If the software is installed on a local computer, setting are stored locally.

In order to accommodate data and/or statistics that may have dramatically differing ranges and origins, it is first necessary to scale the data set to particular ranges of musical and/or sound values. Multiple data sets can be scaled independently and assigned to differing timbres for simultaneous playback. The data element values or the statistical values are then mapped to particular musical characteristics. The mapping may be a direct relationship, or may be a statistical mapping based on the relationship between the data and an historical data set in order to convey the meaning of the relationship between the data element value and its neighbors in the data set. The relationship may be defined by differences between data values and the mean, standard deviation and skewness of the data set or portions thereof and the statistical information on the data set may be used to select a scale (mode), chord progression, key, pitch range or may be used to select a melody or sound from a library of melodies and sounds.

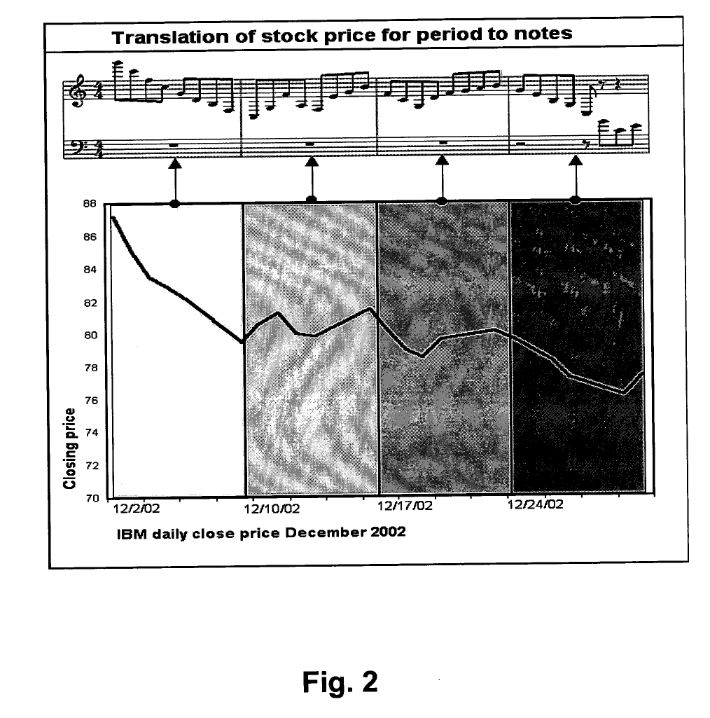

Referring now to FIG. 2, there is illustrated a mapping of pitch to data set independent axis values in accordance with an embodiment of the present invention. The independent data values are of closing price for a stock over the dependent axis time values. The closing price is mapped to musical pitch (note values). The data has been reduced to notes on a c-major scale, but other than that, the melodic relationship is not constrained. The pitch is proportional to the closing price value, and as such, the melody represents the data set (closing price) over the indicated period. A listener hearing the indicated melody receives auditory information from which the shape of the curve can be inferred. Depending on the listener's familiarity with the audio data reviewing process, detailed shape may be perceived by accustomed users, or the gestalt impression of “falling price” may be perceived by others less familiar with audio reviewing.

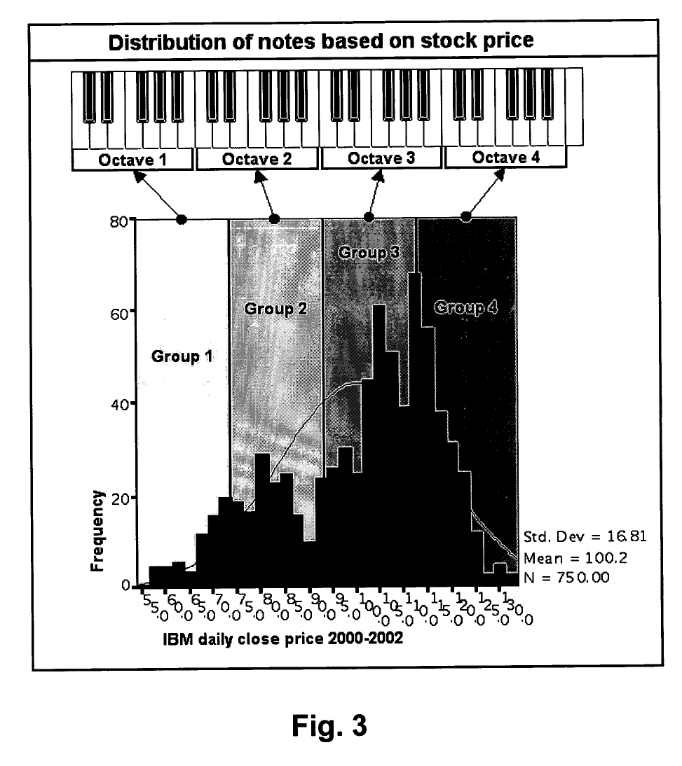

Referring now to FIG. 3, an illustration of pitch range mapping using stock closing price frequency statistics is depicted. Four octave-sized ranges are established within the range of notes used for sound generation (depicted as a piano/organ keyboard). A normal distribution based on statistics of the frequencies of stock prices is used to determine the location of the ranges (note that the mean is actually near the middle of group 3 for this mapping). The actual price values may then be “played” by generating notes in conformity with the stock prices, while the range mapping has been achieved by using the statistics of the data set.

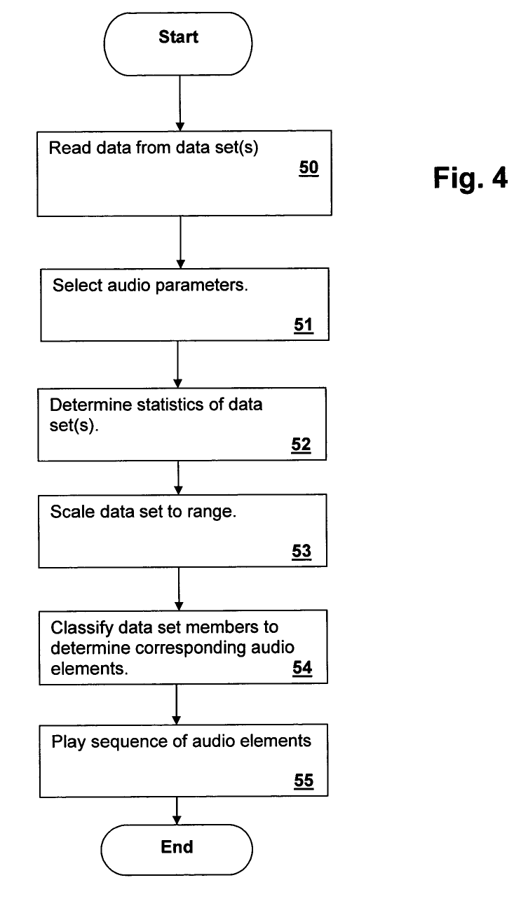

Referring now to FIG. 4, a method in accordance with an embodiment of the invention is illustrated in a flowchart. First the data set or sets are read (step 50) and the audio parameters for mapping to the set are selected (step 51). Next, the data set is analyzed and statistics determined (step 52). Then, the data set or statistical relationship is scaled to the range of audio values desired (step 53). After scaling, the data set members are classified (step 54) to determine corresponding audio elements, which may include mapping deviations in the data to consonant or dissonant intervals. Finally, the sequence of audio elements is played for the user (step 55).

The present invention provides a useful mechanism for use by individuals who are not trained in financial or statistical data analysis in order for them to intuit changes in a portfolio or series of financial positions. The present invention is also suitable as a training and educational tool for statistical or financial analysis. The present invention is also useful as a tool to compare unrelated sets of data such as weather trends, stock prices and traffic patterns, as well as being a tool for use by financial institutions or other professionals for data monitoring without having to visually track indicators.

The method and system of the present invention are also useful for providing background components to newscasts or other presentations as an alternative to a scrolling ticker-tape or other visual presentation. In mobile devices, PDAs and the like, the audio system of the present invention provides eyes-free monitoring of market conditions or other data.

In summary, the present invention provides a tool that is useful in any environment where data must be interpreted rapidly, in real-time or where the listeners have little training in interpretation of data.

While the invention has been particularly shown and described with reference to the preferred embodiments thereof, it will be understood by those skilled in the art that the foregoing and other changes in form, and details may be made therein without departing from the spirit and scope of the invention.

1. A method for providing audible representation of a data set, comprising:
reading said data set, wherein said data set contains an arbitrary non-musical representation of data;
selecting musical parameters for mapping said data set to an audio output;
analyzing said data set to select values of musical elements for playing via said audio output; and
generating a representation of said audio output for playing said musical elements in sequence.

2. The method of claim 1, wherein said analyzing determines statistics of said data set, whereby ranges of said audio elements are selected in conformity with said statistics.

3. The method of claim 1, wherein said analyzing determines statistics of said data set, whereby values of said audio elements are selected in conformity with said statistics.

4. The method of claim 3, wherein said analyzing determines deviations of data values of said data set from said statistics, whereby said audio elements are selected in conformity with said deviations.

5. The method of claim 1, wherein said generating generates a musical output having statistically determined variations, and wherein of said variations are controlled by statistics of said data set.

6. The method of claim 1, wherein said reading reads a data set containing financial data.

7. The method of claim 1, wherein said reading reads multiple data sets, said analyzing is performed for each of said multiple data sets, and wherein said generating generates audio outputs having multiple distinct timbres each assigned to one of said multiple data sets.

8. The method of claim 1, wherein said reading reads multiple data sets, said analyzing is performed for each of said multiple data sets, and wherein said analyzing selects said audio elements in conformity with differences between said data sets.

9. The method of claim 8, wherein said analyzing selects said audio elements in conformity with differences between statistics of said data sets.

10. A computer system for generating an audio output from an arbitrary data set, comprising:
a memory for storing program instructions and data;
a processor coupled to said memory for executing said program instructions; and
an audio output device coupled to said processor for generating audible sound, wherein said program instructions include instructions for:
reading said data set, wherein said data set contains an arbitrary non-musical representation of data,
selecting musical parameters for mapping said data set to an audio output,
analyzing said data set to determine values of musical elements for playing via said audio output, and
generating a representation of said audio output for playing said musical elements in sequence.

11. The computer system of claim 10, wherein said program instructions for analyzing determine statistics of said data set, whereby ranges of said audio elements are determined in conformity with said statistics.

12. The computer system of claim 10, wherein said program instructions for analyzing determine statistics of said data set, whereby values of said audio elements are selected in conformity with said statistics.

13. The computer system of claim 12, wherein said program instructions for analyzing determine deviations of data values of said data set from said statistics, whereby said audio elements are selected in conformity with said deviations.

14. The computer system of claim 10, wherein said program instructions generating generate a musical output having statistically determined variations, and wherein of said variations are controlled by statistics of said data set.

15. The computer system of claim 10, wherein said program instructions for reading read a data set containing financial data.

16. The computer system of claim 10, wherein said program instructions for reading read multiple data sets, said program instructions for analyzing analyze each of said multiple data sets, and wherein said program instructions for generating generate audio outputs having multiple distinct timbres each assigned to one of said multiple data sets.

17. The computer system of claim 10, wherein said program instructions for reading read multiple data sets, said program instructions for analyzing analyze each of said multiple data sets, and wherein said program instructions for analyzing select said audio elements in conformity with differences between said data sets.

18. The computer system of claim 17, wherein said program instructions for analyzing select said audio elements in conformity with differences between statistics of said data sets.

19. A computer program product for generating an audio output from an arbitrary data set, said computer program product comprising signal-bearing media containing program instructions for execution within a general purpose computer, wherein said program instructions comprise program instructions for:
reading said data set, wherein said data set contains an arbitrary non-musical representation of data,
selecting musical parameters for mapping said data set to an audio output,
analyzing said data set to determine values of musical elements for playing via said audio output, and
generating a representation of said audio output for playing said musical elements in sequence.

20. The computer program product of claim 19, wherein said program instructions for analyzing determine statistics of said data set, whereby ranges of said audio elements are determined in conformity with said statistics.

21. The computer program product of claim 19, wherein said program instructions for analyzing determine statistics of said data set, whereby values of said audio elements are selected in conformity with said statistics.

22. The computer program product of claim 21, wherein said program instructions for analyzing determine deviations of data values of said data set from said statistics, whereby said audio elements are selected in conformity with said deviations.

23. The computer program product of claim 19, wherein said program instructions generating generate a musical output having statistically determined variations, and wherein of said variations are controlled by statistics of said data set.

24. The computer program product of claim 19, wherein said program instructions for reading read a data set containing financial data.

25. The computer program product of claim 19, wherein said program instructions for reading read multiple data sets, said program instructions for analyzing analyze each of said multiple data sets, and wherein said program instructions for generating generate audio outputs having multiple distinct timbres each assigned to one of said multiple data sets.

26. The computer program product of claim 19, wherein said program instructions for reading read multiple data sets, said program instructions for analyzing analyze each of said multiple data sets, and wherein said program instructions for analyzing select said audio elements in conformity with differences between said data sets.

27. The computer program product of claim 26, wherein said program instructions for analyzing select said audio elements in conformity with differences between statistics of said data sets.
